(19) United States
(12) Patent Application Publication
(10) Pub. No.: US 2026/0100069 A1
(43) Pub. Date: Apr. 9, 2026

(54) IMAGE MANIPULATION FOR DETECTING A STATE OF A MATERIAL ASSOCIATED WITH THE OBJECT

(71) Applicant: TRINAMIX GMBH, Ludwigshafen (DE)

(72) Inventor: Muhammad Muneeb HASSAN, Ludwigshafen am Rhein (DE)

(21) Appl. No.: 19/115,280

(22) PCT Filed: Oct. 9, 2023
(86) PCT No.: PCT/EP23/77866

§ 371 Date: Mar. 26, 2025

(30) Foreign Application Priority Data
Oct. 25, 2022 (EP) 22203617.0

(51) Int. Cl. G06V 40/40; G06V 10/145; G06V 10/60; G06V 10/774

(52) U.S. Cl. CPC G06V 40/40; G06V 10/145; G06V 10/60; G06V 10/774

(57) ABSTRACT

Disclosed herein is a computer-implemented method for extracting a state of a material associated with an object, the method including:
a) receiving at least one pattern image, where the at least one pattern image shows at least a part of the object under illumination by patterned electromagnetic radiation,
b) changing and/or removing at least a part of the spatial information of the pattern image,
c) determining a state of the material associated with the object based on the at least one pattern image, and
d) providing the state of the material associated with the object.

### TECHNICAL FIELD

The invention relates to a computer-implemented method for extracting a state of a material associated with an object, a computer-implemented method for training a data-driven model, use of a data-driven model for extracting a state of a material, use of a state of a material associated with the object in an authentication process, a use of the at least one pattern image for extracting a state of a material associated with an object and/or use of the state of a material for predicting the presence of a living organism.

### TECHNICAL BACKGROUND

Authentication processes can be spoofed by masks, images or the like representing a user's characteristics. Spoofing items are becoming more realistic and followingly, distinguishing between spoofing object and human becomes more difficult.

Hence, there is a need to reliably differentiate between humans and spoofing items.

An object of the present disclosure is to provide a robust, reliable and secure method for authenticating humans.

### SUMMARY

In one aspect, the disclosure relates to a computer-implemented method for extracting a state of a material associated with an object, the method comprising:
a) receiving at least one pattern image, wherein the at least one pattern image shows at least a part of the object under illumination by patterned electromagnetic radiation,
b) changing and/or removing at least a part of the spatial information of the pattern image,
c) determining a state of the material associated with the object based on the at least one pattern image,
d) providing the state of the material associated with the object.

In another aspect, it relates to a computer-implemented method for training a data-driven model for extracting a state of a material associated with an object, the method comprising:
a) receiving a training data set comprising at least one pattern image with changed and/or removed spatial information and a state of a material associated with an object,
b) training a data-driven model according to the training data set,
c) providing the trained data-driven model.

In another aspect, it relates to a use of a data-driven model for extracting a state of a material associated with the object trained based on a training data set comprising at least one pattern image with changed and/or removed spatial information and a state of a material associated with an object.

In another aspect, it relates to a use of a state of a material associated with the object in an authentication process for initiating and/or validating the authentication of a user.

In another aspect, it relates to a use of the at least one pattern image with changed and/or removed spatial information for extracting a state of a material associated with an object and/or use of the state of a material associated with an object for predicting the presence of a living organism.

In another aspect, it relates to a use of the at least one pattern image with changed and/or removed spatial information for extracting a state of a material associated with an object and/or use of the state of a material associated with an object for predicting the presence of a living organism.

In another aspect, it relates to a computer program element with instructions, which when executed on a processing device is configured to carry out the steps of the methods described herein.

In another aspect, it relates to a non-transitory computer-readable data medium storing a computer program including instructions for executing steps of the method as described herein.

The present disclosure provides means for an efficient, robust, stable and reliable method for extracting a state of the material associated with an object. State of a material associated with an object are of key importance when it comes to detecting spoofing attacks in an authentication process. Commercial authentication systems can be easily spoofed with silicon masks. Blood perfusion can be used as an effective distinguishing feature between a spoofing mask and a real human. Blood perfusion may be detected by detecting a state of the material associated with an object. In images used for detecting a state of the material associated with an object spatial feature such as nose, nail, bone, shape of body part or the like are easy to recognize but also easy to imitate, especially with modern hyper realistic masks or similar spoofing objects. Followingly, relying only on spatial features for authentication constitutes a safety risk. In addition, suppressing at least a part of the spatial information of an image enables an easy determination of the state of a material by withdrawing attention from spatial information. This is especially important in the case of a data-driven model which learn from a training data set to discriminate real humans from spoofing objects. Changing and/or removing at least a part of the spatial information of a pattern image provides a method for suppressing and/or removing spatial features that are overshadowing the essential information for determining a state of the material associated with an object. Hence, recognizing and/or authenticating a user is enhanced by predicting the likelihood of an object being a living organism via determining a state of a material. Additionally, using images with suppressed spatial information may be used for training a model, in particular a data-driven model, more effectively.

Based on the state of a material associated with the object, it is possible to reliably decide whether a living organism has been presented to a camera. It is a particular advantage, that the method is robust against spoofing, e.g., by presenting a mask or the like that replicates the authorized user's face to the camera. It is a further advantage of the method according to the disclosure that the pattern image can be recorded using standard equipment, e.g., a standard laser and a standard camera, e.g., comprising a charge coupled device (CCD) and/or a complementary metal oxide semiconductor (CMOS) sensor element. Furthermore, an efficient and robust way for monitoring a condition of a living organism is provided. The feature contrast of a plurality of pattern images can be used to determine a condition measure such as the heartbeat, blood pressure, aspiration level or the like. E.g. the heartbeat is a sensitive measure for the condition of a living organism, especially the stress level or similar factors indicated by the condition measure. Thus, monitoring the living organism allows for identifying situations where the living organism is e.g. stressed and corresponding actions may be taken on the basis of the condition measure determined. Identifying these situations is especially important where critical condition measures provide a health or security risk. Examples for these situations may be a driver controlling a vehicle, a user using a virtual reality headset or a person having to take a far-reaching decision. By identifying such situations, the security risk and the health risk in these situations is decreased. Furthermore, the disclosure presented herein makes use of inexpensive hardware for monitoring the living organism. In addition to that, the disclosed methods, systems, computer hardware and uses are easy to integrate and conduct and no direct contact to a living organism is required by providing at the same time reliable results. Thus, the living organism is not limited in any way by the monitoring and by deploying light in the IR range the living organism may not recognize the monitoring being performed. Therefore, the living organism is not distracted by light or feels observed by deploying the methods, systems, computer-readable storage media and use of signals disclosed herein.

### EMBODIMENTS

The disclosure takes into account that a moving body fluid or moving particles in the body of a living organism, such as blood cells, in particular, red blood cells, interstitial fluid, transcellular fluid, lymph, ions, proteins and nutrients, may cause a motion blur to reflected light. Non-moving objects do not cause a motion blur. Thus, if coherent electromagnetic radiation is reflected by moving scattering particles like red blood cells, the speckle pattern fluctuates and speckles become blurred. As a consequence of this blurring, the speckle contrast decreases. Therefore, the speckle pattern and the speckle contrast derived from the speckle pattern contain information about whether or not the illuminated object is a living organism. Speckle contrast values are generally distributed between 0 and 1. When illuminating an object, the value 1 may represent no motion and the value 0 may represent the fastest motion of particles thus causing the most prominent blurring of the speckles. Since the state of a material associated with an object may be determined based on the speckle contrast, the lower is the speckle contrast value, the higher is the certainty that a corresponding state of a material associated with an object indicates the presence of a living organism. On the contrary, the higher is the speckle contrast value, the higher is the certainty that a corresponding state of a material associated with an object indicates the presence of an object that is not a living organism.

In the following, terminology as used herein and/or the technical field of the present disclosure will be outlined by ways of definitions and/or examples. Where examples are given, it is to be understood that the present disclosure is not limited to said examples.

As used herein, living organism and living species may be used interchangeably.

Methods, system, uses, computer program element may be used for predicting the presence of a living organism. Thus, method, system, uses, computer program element may be applied to non-living objects. It is advantageous to apply the methods, system, uses, computer program element to all kind of objects in order to distinguish between living organism s and non-living objects.

In an embodiment, patterned electromagnetic radiation may be coherent electromagnetic radiation. Coherent electromagnetic radiation may refer to electromagnetic radiation that is able to exhibit interference effects. It may also include partial coherence, i.e. a non-perfect correlation between phase values. In some embodiments, coherent electromagnetic radiation may be in the infrared range, in particular the near-infrared range. Coherent electromagnetic radiation may be generated by a light source. Light source may be a part of a device and/or system. As an example, the coherent electromagnetic radiation may have a wavelength of 300 to 1100 nm, especially 500 to 1100 nm. Additionally or alternatively, light in the infrared spectral range may be used, such as in the range of 780 nm to 3.0 um. Specifically, the coherent electromagnetic radiation in the part of the near infrared region where silicon photodiodes are applicable specifically in the range of 700 nm to 1100 nm may be used. Using coherent electromagnetic radiation in the near infrared region allows that coherent electromagnetic radiation is not or only weakly detected by human eyes and is still detectable by silicon sensors, in particular standard silicon sensors.

In an embodiment, patterned electromagnetic radiation may comprise a speckle pattern. Speckle pattern may comprise at least one speckle. A speckle pattern may refer to an arbitrary known or pre-determined arrangement comprising at least one arbitrarily shaped speckle. The speckle pattern may comprise an arrangement of periodic or non-periodic speckles. The speckle pattern can be at least one of the following: at least one quasi random pattern; at least one Sobol pattern; at least one quasiperiodic pattern; at least one point pattern, in particular a pseudo-random point pattern; at least one line pattern; at least one stripe pattern; at least one checkerboard pattern; at least one triangular pattern; at least one rectangular pattern; at least one hexagonal pattern or a pattern comprising further convex tilings. A speckle pattern may be an interference pattern generated from coherent electromagnetic radiation reflected from an object, e.g., reflected from an outer surface of that object or reflected from an inner surface of that object. A speckle pattern typically occurs in diffuse reflections of coherent electromagnetic radiation such as laser light. Within the speckle pattern, the spatial intensity of the coherent electromagnetic radiation may vary randomly due to interference of coherent wave fronts. A speckle is at least a part of a speckle pattern. Speckle may comprise at least partially an arbitrarily shaped symbol. The symbols can be any one of: at least one point; at least one line; at least two lines such as parallel or crossing lines; at least one point and one line; at least one arrangement of periodic speckles; at least one arbitrary shaped speckle pattern.

In an embodiment, object may refer to an arbitrary object. Object may include living organisms such as humans and animals. State of the material may be determined for an object in an image. Image may include more than the object a state of the material may be determined for. Image may further include background. Background may refer to objects for which no vital sign measure may be determined. pattern image may include at least a part of the object and/or background. Preferably, an object may be a body part. Body part may be an external body part. Examples may be head, forehead, face, haw, cheek, chin, eye, ear, nose, mouth, arm, leg, foot or the like.

In an embodiment, a state of a material associated with an object may refer to information related to the material associated with the object. State of a material may be usable for classifying a material and/or object. State of a material may be a chemical state of the material, a physical state of the material, a material type and/or a biological state of the material. State of a material may comprise information associated with a chemical state of the material, a physical state of the material and/or a biological state of the material. Chemical state of the material may indicate a composition of a material. An example for a composition may be ironoxide or PVC. Material type may indicate the kind of material. Material type may be derived from the chemical state of the material, the physical state of the material, and/or the biological state of the material. Example for material type may be silicon, metal, wood or the like. Skin may comprise more than one chemical compound. Skin as may be determined based on the more than one chemical compound. Skin may be for example determined based on a biological state of a material, e.g. blood perfusion. Physical state of the material may indicate structure of the object associated with the material, orientation of the object and/or the like. Structure of the object may comprise information related to the surface structure and/or inner structure. For example, structure of the object may comprise topological information, periodic arrangement and/or the like. Biological state of the material may indicate a vital sign, a vital sign measure, a condition measure, type of biological material and/or the like. A biological material type may be skin such as human and/or animal specific skin. State of the material may comprise at least one numerical value.

In an embodiment, a vital sign may be indicative of the presence of a living organism. Vital sign may refer to information related to the presence of a living organism. In other words, a vital sign is any sign suitable for distinguishing a living organism from a non-living object. In particular, a vital sign may relate to the presence of a moving body fluid or moving particles in the body of a living organism. In this regard, the presence of blood flow, e.g. of red blood cells, may be a preferred vital sign. However, other moving body fluids or moving particles present in the body of a living organism may also be used as a vital sign such as interstitial fluid, transcellular fluid, lymph, ions, proteins and nutrients. Preferably, the vital sign may be detectable by analysing a speckle pattern, e.g., by detecting blurring of speckles caused by moving body fluid or moving particles in the body of a living organism. This blurring may decrease a speckle contrast in comparison to a case in which no moving body fluid or moving particles are present.

In an embodiment, at least one state of a material associated with the object may refer to at least one measure indicative of whether the object may show a vital sign. The at least one vital sign measure may be determined based on a speckle contrast. Thus, the at least one vital sign measure may depend on the determined speckle contrast. If the speckle contrast changes, the at least one vital sign measure derived from the speckle contrast may change accordingly. At least one vital sign measure may be at least one single number and/or value that may represent a likelihood that the object may be a living organism. Additionally or alternatively, a vital sign measure may comprise a Boolean value, e.g. true for living organism s and false for non-living objects or vice versa.

In an embodiment, spatial information may comprise information related to the spatial orientation of the object and/or to the contour of the object and/or to the edges of the object. Spatial information may be classified via a model, in particular a classification model. Spatial information may be associated with spatial features. Spatial features of a face may be facial features. Spatial feature may be represented with a vector. Vector may comprise at least one numerical value.

Example for spatial features of a face may comprise at least one of the following: the nose, the eyes, the eyebrows, the mouth, the ears, the chin, the forehead, wrinkles, irregularities such as scars, cheeks including cheekbones or the like. Other examples for spatial information may include finger, nails or the like. At least a part of the spatial information may be removed by removing at least a part of the spatial features and/or changing at least a part of the spatial features. Removing at least a part of the spatial features may be associated with removing data related to spatial features. Changing and/or removing at least a part of the spatial features may be associated with changing data related to spatial features.

In an embodiment, changing and/or removing at least a part of spatial information may comprise performing at least one image augmentation technique, in particular any combinations of at least two image augmentation techniques. Performing at least one image augmentation technique may comprise changing the distance between at least two spatial features, representing the object as a two-dimensional plane, changing at least a part of the image, deleting at least a part of the image, rearranging at least a part of the image, generating at least one partial image and/or all combinations thereof. Changing the distance between at least two spatial features may include changing the at least two positions associated with the at least two spatial features. Representing the object as a two-dimensional plane may comprise generating a UV map, a flattened representation of the object, a distorted image, a warped image and/or the like. Representing the object as a two-dimensional plane may result in a pattern image with different distances between features in the pattern image compared to the pattern image generated. For example, a pattern image may show a face and the pattern image may be sheared. As a result, the eyes may be more distant in the pattern image and the nose may be closer to the right eye after shearing than in the pattern image generated. Consequently, a model may not recognize a face due to the unknown and/or unexpected spatial expansion of facial features. Changing at least a part of the image may comprise changing the at least one spatial feature, changing distances between at least two parts of the at least one spatial feature, changing brightness, changing contrast, blurring the image, deleting at least a part of the at least one spatial feature, changing shape of the at least one spatial feature to an arbitrary shape, changing size of the at least one spatial feature and/or the like. Deleting at least a part of the image may comprise deleting at least a part of at least one spatial feature. Rearranging at least a part of the pattern image may comprise changing a position of at least a part of the pattern image. Partial image may be of arbitrary size and/or shape. Changing and/or removing at least a part of the spatial information of a pattern image may result in a manipulated pattern image with different, less or no spatial information. Changing and/or removing at least a part of the spatial information of at least a part of the pattern image may be associated with changing and/or removing data related to spatial information. Manipulating an image, in particular a pattern image, may be referred to as changing and/or removing at least a part of the spatial information of at least a part of the image. A manipulated image may be an image with changed and/or removed spatial information of the at least a part of the pattern image.

In particular, performing at least one image augmentation technique may comprise changing the distance between at least two spatial features, representing the object as a two-dimensional plane, deleting at least a part of the image, rearranging at least a part of the image, generating at least one partial image and/or all combinations thereof. More preferably, performing at least one image augmentation technique may comprise changing the distance between at least two spatial features, deleting at least a part of the image, rearranging at least a part of the image and/or generating at least one partial image. More preferably, performing at least one image augmentation technique may comprise changing the distance between at least two spatial features, deleting at least a part of the image, and/or generating at least one partial image. More preferably, performing at least one image augmentation technique may comprise changing the distance between at least two spatial features and/or generating at least one partial image. More preferably, performing at least one image augmentation technique may comprise deleting at least a part of the image, and/or generating at least one partial image. More preferably, performing at least one image augmentation technique may comprise deleting at least a part of the image, and/or changing the distance between at least two spatial features. More preferably, performing at least one image of mentation technique may comprise deleting at least a part of the image and/or changing at least of the image, in particular changing at least a part of a spatial feature.

In an embodiment, image augmentation techniques may comprise at least one of scaling, cutting, rotating, blurring, warping, shearing, resizing, folding, changing the contrast, changing the brightness, adding noise, multiply at least a part of the pixel values, drop out, adjusting colors, applying a convolution, embossing, sharpening, flipping, averaging pixel values or the like. Image augmentation techniques may be performed for changing and/or removing at least a part of the spatial information. For example, at least a part of the spatial information may be changed and/or removed by shearing the pattern image. Shearing the pattern image may for example result in changing the distance between at least two spatial features and/or changing at least one spatial feature. Hence, performing at least one of the image augmentation techniques may result in changing and/or removing at least a part of the spatial information of at least one pattern image. At least a part of spatial information of a pattern image may be changed and/or removed by performing at least one of image augmentation techniques, in particular any combinations of image augmentation techniques. See advanced Graphics Programming Using OpenGL-A volume in The Morgan Kaufmann Series in Computer Graphics by TOM McREYNOLDS and DAVID BLYTHE (2005) ISBN 9781558606593, https://doi.org/10.1016/B978-1-55860-659-3.50030-5 for a non-exhaustive list of image augmentation techniques.

In an embodiment, at least a first image augmentation technique may be performed on the at least one pattern image. Additionally or alternatively, a combination of at least two image augmentation techniques comprising at least a first image augmentation technique and at least a second image augmentation technique may be performed on the at least one pattern image. Additionally or alternatively, a combination of at least two image augmentation techniques comprising at least a second image augmentation technique may be performed on the at least one pattern image.

In an embodiment, the at least one image augmentation technique may be varied. Varying the at least one image augmentation technique may comprise performing at least one of the image augmentation techniques may be different for at least a first part of the at least one pattern image compared to at least second part of the at least one pattern image. Performing at least one of the image augmentation techniques can be randomized by selecting at least one of image augmentation techniques randomly. Performing at least one of the image augmentation techniques maybe varied based on a predetermined sequence of image augmentation techniques. Performing at least one of image augmentation techniques randomly may comprise selecting a sequence of at least two image augmentation techniques randomly. Furthermore, performing at least one of image augmentation techniques randomly may comprise selecting parameters suitable for defining how the image augmentation technique may be applied randomly. Examples for parameters suitable for defining how the image augmentation technique may be applied may be rotation angle, scaling parameters, shearing factor, parameters defining warping, parameters defining position, number and length of cuts or the like. Randomizing the change or removal of spatial features is advantageous since this creates images with deviating shape of the object. By doing so, shape of the object in the image is variable and is thus not taken into account when analyzing the state of the material.

Spatial information may be recognized by models, in particular data-driven models. In situations where an image includes more than one type of information that a model can focus on, the model will focus on the most prominent features. A pattern image includes information related to a vital sign and spatial information. A model, in particular a data-driven model, may tend to focus too much on spatial information which is less effective for detection of a living organism rather than focusing on the relevant features, for example information related to a state of a material such as a vital sign. Removing and/or changing at least a part of the spatial information will focus the model on the information related to a vital sign. Hence, model is trained more efficiently and results/output of the model is more accurate. Removing at least a part of the spatial information may change at least a part of the spatial information. Changing at least a part of the spatial information may remove at least a part of the spatial information. Depending on the object in the image and the state of the material associated with the object to be determined different image augmentation techniques may be chosen. Different image augmentation techniques may influence the degree of change or removal differently.

In an embodiment, processor may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semi-conductor based processor, a quantum processor, or any other type of processor configures for processing instructions. As an example, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

In an embodiment, input and/or output may comprise of one or more of serial or parallel interfaces or ports, USB, Centronics Port, FireWire, HDMI, Ethernet, Bluetooth, RFID, Wi-Fi, USART, or SPI, or analogue interfaces or ports such as one or more of ADCs or DACs, or standardized interfaces or ports to further devices.

In an embodiment memory may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

In an embodiment, system may comprise at least one computing node. A computing node may refer to any device or system that includes at least one physical and tangible processor, and a physical and tangible memory capable of having thereon computer-executable instructions that are executed by a processor. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In an embodiment at least one wireless communication protocol may be used. The wireless communication protocol may comprise any known network technology such as GSM, GPRS, EDGE, UMTS/HSPA, LTE technologies using standards like 2G, 3G, 4G or 5G, The wireless communication protocol may further comprise a wireless local area network (WLAN), e.g. Wireless Fidelity (Wi-Fi).

In an embodiment system may be a distributed computing environment. Distributed Computing may be implemented. Distributed computing may refer to any computing that utilizes multiple computing resources. Such use may be realized through virtualization of physical computing resources. One example of distributed computing is cloud computing. “Cloud computing” may refer a model for enabling on-demand network access to a shared pool of configurable computing resources (e.g., networks, servers, storage, applications, and services). When distributed, cloud computing environments may be distributed internationally within an organization and/or across multiple organizations.

In an embodiment, computer-readable data medium may refer to any suitable data storage device or computer readable memory on which is stored one or more sets of instructions (for example software) embodying any one or more of the methodologies or functions described herein. The instructions may also reside, completely or at least partially, within the main memory and/or within the processor during execution thereof by the computer, main memory, and processing device, which may constitute computer-readable storage media. The instructions may further be transmitted or received over a network via a network interface device. Computer-readable data medium include hard drives, for example on a server, USB storage device, CD, DVD or Blue-ray discs. The computer program may contain all functionalities and data required for execution of the method according to the present disclosure or it may provide interfaces to have parts of the method processed on remote systems, for example on a cloud system. The term non-transitory may have the meaning that the purpose of the data storage medium is to store the computer program permanently, in particular without requiring permanent power supply.

In an embodiment, steps of the methods as described herein may be performed by a device. Device may be a mobile device and/or a stationary device. Mobile device may comprise a tablet, a laptop, a phone, a watch or the like. Stationary device may be a device suitable for installing permanently at a fixed position. Stationary device may for example a computer, a desktop computer, a server, a cloud environment or the like.

In an embodiment, determining a state of the material associated with the object based on the at least one pattern image may include determining a speckle contrast of at least a part of the pattern image.

In an embodiment, at least one further pattern image and an indication of at least one interval between at least two different points in time, where the at least two pattern images have been generated, may be received, and wherein a speckle contrast is determined for the at least two pattern images, and wherein a state of the material associated with the object is determined based on the speckle contrast and the indication of the at least one time interval.

In an embodiment, at least two pattern images and an indication of at least one interval between at least two different points in time, where the at least two pattern images have been generated, are received, and wherein a speckle contrast is determined for the at least two pattern images, and wherein a state of the material associated with the object is determined based on the speckle contrast and the indication of the at least one time interval.

In an embodiment, at least one pattern image may comprise image data suitable for representing at least one pattern image. Image may be a pattern image. Partial image may be an image. Pattern image may comprise at least one pattern comprising at least a pattern feature. Pattern feature may be a speckle. Pattern image may not be limited to an actual visual representation of an object. Instead, a pattern image may comprise data generated while illuminating an object with patterned electromagnetic radiation. Pattern image may be comprised in a larger pattern image. Pattern image may show and/or may comprise at least one speckle pattern. Pattern may be a speckle pattern comprising at least one speckle. A larger pattern image may be a pattern image comprising more pixels than the pattern image comprised in it. Dividing a pattern image into at least two parts may result in at least two pattern images. The at least two pattern images may comprise different data generated based on light reflected by an object being illuminated with coherent electromagnetic radiation. Pattern image may be suitable for determining a speckle contrast. Speckle contrast may be determined for at least one speckle. Pattern image may comprise a plurality of pixels. A plurality of pixels may comprise at least two pixels, preferably more than two pixels. For determining a speckle contrast at least one pixel associated with the reflection feature and at least one pixel not associated with the speckle may be suitable. Pattern image can refer to any data based on which an actual visual representation of the imaged object can be constructed. For instance, the data can correspond to an assignment of color or grayscale values to image positions, wherein each image position can correspond to a position in or on the imaged object. The pattern images can be two-dimensional, three-dimensional or four-dimensional, for instance, wherein a four-dimensional image is understood as a three-dimensional image evolving over time and, likewise, a two-dimensional image evolving over time might be regarded as a three-dimensional image. A pattern image can be considered a digital image if the data are digital data, wherein then the image positions may correspond to pixels or voxels of the image and/or image sensor.

In an embodiment, a speckle pattern may comprise at least two speckles, preferably at least three speckles. Two or more speckles provide a larger amount of information than compared to one speckle. Further information is advantageous since more results and in total a more accurate result can be obtained. Followingly, providing more information increases the accuracy of corresponding results.

In an embodiment, determining a state of the material may comprise based on at least one pattern image may comprise providing the at least one pattern image to a data-driven model for determining the state of the material. The data-driven model may be parametrized and/or trained to receive the at least one pattern image and to determine the state of the material from the pattern image. The data-driven model may be parametrized and/or trained according to a plurality of pattern images and corresponding states of material.

In an embodiment, a state of the material associated with the object may be determined based on a speckle contrast of at least a part of the pattern image.

In an embodiment, determining a state of a material may comprise applying at least one image filter. Determining a state of a material may comprise applying an image filter, in particular, a material dependent image filter. Image filter may be applied to at least a part of the pattern image. Hence image filter may be applied to at least one speckle. Such a technique is for example described in WO 2020/187719 A1 and is described herein below. The disclosure of WO 2020/187719 A1 is hereby incorporated by reference.

A speckle contrast may represent a measure for a mean contrast of an intensity distribution within an area of a speckle pattern. The speckle contrast may be determined for a first speckle of at least two pattern images and for a second speckle of at least two pattern images. The speckle contrast may be determined separately for the at least two speckles of the at least two pattern images.

In particular, a speckle contrast K over an area of the pattern may be expressed as a ratio of standard deviation σ to the mean speckle intensity <I>, i.e.,

$$K = \frac{σ}{〈 I 〉}$$

Speckle contrast values are generally distributed between 0 and 1. Speckle contrast may comprise and/or may be associated with a speckle contrast value. Speckle contrast may be determined based on at least one speckle. Followingly, at least two values for a speckle contrast may be determined based on the at least two speckles.

When referring to determining a speckle contrast or a state of the material associated with an object and/or determining at least one value for the state of the material associated with an object and/or speckle contrast is included.

In some embodiments, for determining the speckle contrast, the complete speckle pattern of the pattern image may be used. Alternatively, for determining the speckle contrast, a section of the speckle pattern may be used. The section of the speckle pattern, preferably, represents a smaller area of the speckle pattern than an area of the speckle pattern. The area may be of any shape. The section of the speckle pattern may be obtained by cropping the pattern image. The speckle contrast may be different for different parts of an object. Different parts of the object may correspond to different parts of the pattern image. Followingly, the speckle contrast may be different for different parts of a pattern image.

A condition measure is a measure suitable for determining the condition of a living organism. A condition of a living organism may be a physical and/or mental condition. A physical condition may be associated with physical stress level, fatigue, excitation, suitability of performing a certain task of a living organism or the like. A mental condition may be associated with mental stress level, attentiveness, concentration level, excitation, suitability of performing a certain task of a living organism or the like. Such a certain task may require concentration, attention, wakefulness, calming or similar characteristics of the living organism. Examples for such a task can be controlling machinery, vehicle, mobile device or the like, operating on another living organism, activities relating to sports, playing games, tasks in an emergency case, making decisions or the like. Condition measures indicate a condition of a living organism. Condition measures may be one or several of the following: heart rate, blood pressure, aspiration level or the like. In some embodiments, the condition of a living organism may be critical corresponding to a high value of the condition measure and the condition of a living organism may be non-critical corresponding to a low value of the condition measure. Followingly, the critical condition measure according to these embodiments may be equal or lower than a threshold and a non-critical condition measure may be lower than a threshold. In other embodiments, the condition of a living organism may be critical corresponding to a low value of the condition measure and the condition of a living organism may be non-critical corresponding to a high value of the condition measure. Followingly the critical condition measure according to these embodiments may be equal or higher than a threshold and a non-critical condition measure may be lower than a threshold. A critical condition measure may be associated with a high stress level, low attentiveness, low concentration level, high fatigue, high excitation, low suitability of performing a certain task of the living organism or the like. A non-critical condition measure may be associated with a low stress level, high attentiveness, high concentration level, low fatigue, low excitation, high suitability of performing a certain task of the living organism or the like.

In an embodiment, a condition measure may be determined based on a speckle contrast of at least a part of the pattern image. The condition measure of a living organism may be determined based on the motion of a body fluid, preferably blood, most preferably red blood cells. The motion of body fluids is not constant over time but changes due to activity of parts of the living organism, e.g the heart. Such a change in motion may be determined based on a change in speckle contrast over time. A high difference between values of speckle contrast at different points in time may be associated with a fast change in motion. A low difference between values of speckle contrast at different points in time may be associated with a slow change in motion. The change in motion of a body fluid, preferably blood, may be periodically associated with a corresponding motion frequency. Accordingly, the speckle contrast may change periodically with the corresponding motion frequency. The motion frequency may correspond to the length of a period associated with the periodic change in speckle contrast. In some embodiments, half of a period may be comprised in the at least two pattern images. In other embodiments, one or several periods may be comprised in the at least two pattern images. Preferably, speckle associated with the same part of a living organism may be used for determining the condition of a living organism. This is advantageous due to the fact that the blood perfusion and thus, the speckle contrast across different parts of the body varies. In some embodiments, at least one condition measure may be determined based on the speckle contrast.

The at least two pattern images comprise a time series. The time series may comprise pattern images separated by a constant time interval associated with an imaging frequency or changing time intervals. Preferably, the time series is constituted such that the imaging frequency is at least twice the motion frequency. This is known as the Nyquist theorem. For higher resolution more pattern images than at least required by the Nyquist theorem may be received.

In an embodiment, an indication of an interval between the different points in time where the at least two pattern images are generated may be received. The indication of the interval comprises measure(s) suitable for determining the time between the different points in time where the at least two pattern images are generated.

A frequency is a reciprocal value of the length of a period. The length of a period may be determined by the interval between two pattern images comprising a share of the period of the heart beating or the heart cycle. In a normal human at rest the heart beats between 60 and 80 times per minute corresponding to a resting heart rate of 60 to 80 beats per minute (bpm). The resting heart rate may be lower, e.g. if the human is sportive or suffers from bradycardia. In situation where the human is active, the heart rate may increase up to 230 bpm. Animals may have heart rates ranging from 6 to 1000 bpm. The pattern images may be generated depending on the expected heart rate of the living organism examined. The interval between the pattern images may be chosen to be up to 10 seconds. In the case of a human, the interval may be chosen up to 2 seconds. Followingly, the imaging frequency may be chosen to be at least 12 pattern images per minute or at least 60 pattern images in the case of a human. In an example, the method may be used for determining the heart rate of a human. For this purpose, an imaging frequency of 60 images per minute may be chosen. As the speckle contrast is determined, one may recognize that the imaging frequency may be too low. In such a case, the imaging frequency may be increased such that the condition measure may be determined. Alternatively, the imaging frequency for imaging a human may be chosen to be a high frequency such as 460 images per minute. A heart rate may be determined based on the at least two pattern images and an indication of the interval between the at least two different points in time indicating an interval of 0.13 seconds. In the example, the human may have a heart rate in the range of 60 to 80 bpm. Followingly, the imaging frequency may be adjusted according to expected and/or predetermined condition measures.

In an example, the interval may comprise a half, a full, double length of a period or the like. The interval may be between at least two pattern images. Followingly, the at least two pattern images may be separated by a half, a full, double length of a period or the like. In the exemplary case of three pattern images indication of one or two different intervals may be received. If more than two pattern images are received, the indication of the interval may comprise an indication of an interval between the first and the second pattern image and/or an interval between the first and the third pattern image (or every other pattern image if more than three pattern images may be received) and/or an interval between the second and the third pattern image (or every other pattern image if more than three pattern images may be received). This applies accordingly to other scenarios with a different amount of pattern images as the skilled person will recognize. Measures for the indication of the interval may be at least two points in time corresponding to the different points in time where the at least two pattern images are generated and/or the time that passed between the different points in time and/or an imaging frequency associated with the generation of the pattern images. The at least two points in time may be determined based on a timestamp of the at least two pattern images. The imaging frequency may comprise a selected value. The imaging frequency may be selected based on the expected condition measure, e.g. an expected heart rate. Alternatively, the image frequency of a video may be used to determine an imaging frequency. An expected heart rate may comprise a heart rate associated with the living organism monitored. In some embodiments, estimation of condition measure may be used to select the imaging frequency. An estimation of condition measure may take the living organism and its surrounding into account.

Monitoring the living organism allows for identifying situations where the living organism is e.g. stressed and corresponding actions may be taken on the basis of the condition measure determined. Identifying these situations is especially important where critical condition measures provide a health or security risk. Examples for these situations may be a driver controlling a vehicle, a user using a virtual reality headset or a person having to take a far-reaching decision. By identifying such situations, the security risk and the health risk in these situations is decreased. Furthermore, the method and system for monitoring a condition makes use of inexpensive hardware for monitoring the living organism. In addition to that, the method and system for monitoring a condition is easy to integrate and conduct and no direct contact to a living organism is required by providing at the same time reliable results. Thus, the living organism is not limited in any way by the monitoring and by deploying light in the IR range the living organism may not recognize the monitoring being performed. Therefore, the living organism is not distracted by light or feels watched by deploying the methods, systems, computer-readable storage media and use of signals disclosed herein.

These and other objects, which become apparent upon reading the following description, are solved by the subject matters of the independent claims. The dependent claims refer to embodiments of the invention.

In an embodiment, more than one state of the material associated with an object may be determined based on more than one pattern image including partial pattern images. In particular, the at least two parts of the pattern images may be associated with different spatial position on the object. Different spatial positions may refer to overlapping or different spatial positions of the object. Based on the at least two parts of the at least two pattern images at least two states of the material associated with an object may be determined associated with the two different spatial positions. Further, the at least two states of the material associated with an object may be provided as a material state map. A material state map can be generated from a speckle contrast map. A speckle contrast map may comprise a number of speckle contrast values each being associated with a position, e.g. a position on the object at which a corresponding pattern image has been recorded. A speckle contrast map may be represented using a matrix having speckle contrast values as matrix entries. A material state map may be represented by a matrix containing individual states of the material associated with an object as matrix entries. A material state map may represent a spatial distribution of the determined state of a material associated with an object. Each of the states of the material associated with an object may be associated with a different position on the object at which the object has been illuminated with coherent electromagnetic radiation for recording the corresponding speckle pattern. Thus, it can be beneficial, if a state of the material associated with an object is associated with a position on the object. For generating the map of states of the material associated with an object, the positions associated with the respective states of the material associated with an object can be taken into account. Thus, a map may represent a spatial distribution of states of the material associated with an object, e.g., in the coordinate system of the illuminated object. For example, a position associated with a state of the material associated with an object may be represented by a spatial coordinate in the coordinate system of the illuminated object. A map of state of the material associated with an object is advantageous since at least two states of the material associated with an object are determined for different parts of an object and thus, accuracy may be improved due to an increased number of tests. An example for a material state map may be a vital sign measure map. Another example may be a material type map. Speckle contrast map may comprise a plurality of speckle contrast values. Speckle contrast map may be represented similar to the blood perfusion map 510-530 by representing the values associated with the speckle contrast. By assigning a speckle contrast with a state of a material associated with an object, a material state map can be generated. Assigning the speckle contrast with a state of a material associated with an object may comprise comparing speckle contrast with a predetermined threshold. Several thresholds may be used to obtain a graded representation as shown in FIG. 5.

Value may be included when referring to speckle contrast, vital sign measure, vital sign, state of a material associated with the object or the like.

In an embodiment, material type map may indicate the material type of at least two different spatial positions in the pattern image. Object may comprise of more than one material. Different spatial positions may be associated with different material types. In the example, one part of the pattern image may show one material type and the other part may show another material type. By doing so, more information about the object may be generated and one may account for different state of the material associated with the object at different spatial locations of the object.

In some embodiments, the state of a material associated with an object may be determined using a model. A model may be a deterministic model, a data-driven model or a hybrid model. The deterministic model, preferably, reflects physical phenomena in mathematical form, e.g., including first-principle models. A deterministic model may comprise a set of equations that describe an interaction between the material and the patterned electromagnetic radiation thereby resulting in a condition measure, a vital sign measure or the like. A hybrid model may be a classification model comprising at least one machine-learning architecture with deterministic or statistical adaptations and model parameters. Statistical or deterministic adaptations may be introduced to improve the quality of the results since those provide a systematic relation between empiricism and theory. Statistical or deterministic adaptations may comprise limitations of any intermediate or final results determined by the classification model and/or additional input for (re-) training the classification model. A hybrid model may be more accurate than a purely data-driven model since, especially with small data sets, purely data-driven models may tend to overfitting. This can be circumvented by introducing knowledge in the form of deterministic adaptations.

In an embodiment, the data-driven model may be a classification model. The classification model may comprise at least one machine-learning architecture and model parameters. For example, the machine-learning architecture may be or may comprise one or more of: linear regression, logistic regression, random forest, piecewise linear, nonlinear classifiers, support vector machines, naive Bayes classifications, nearest neighbours, neural networks, convolutional neural networks, generative adversarial networks, support vector machines, or gradient boosting algorithms or the like. In the case of a neural network, the model can be a multi-scale neural network or a recurrent neural network (RNN) such as, but not limited to, a gated recurrent unit (GRU) recurrent neural network or a long short-term memory (LSTM) recurrent neural network.

The data-driven model may be parametrized according to a training data set. The data-driven model may be trained based on the training data set. Training the model may include parametrizing the model. The term training may also be denoted as learning. The term specifically may refer, without limitation, to a process of building the classification model, in particular determining and/or updating parameters of the classification model. Updating parameters of the classification model may also be referred to as retraining. Retraining may be included when referring to training herein. In an embodiment, the training data set may include at least one pattern image with changed and/or removed spatial information and at least one state of a material, eg at least one vital sign measure. Vital sign measure may be vital sign measure associated with the at least on pattern image.

The classification model may be at least partially data-driven. Training the data-driven model may comprise providing training data to the model. The training data may comprise at least one training dataset. A training data set may comprise at least one input and at least one desired output. During the training the data-driven model may adjust to achieve best fit with the training data, e.g. relating the at least on input value with best fit to the at least one desired output value. For example, if the neural network is a feedforward neural network such as a CNN, a backpropagation-algorithm may be applied for training the neural network. In case of a RNN, a gradient descent algorithm or a backpropagation-through-time algorithm may be employed for training purposes. Training a model may include or may refer without limitation to calibrating the model.

In an embodiment, the at least one pattern image may further show at least a part of background under illumination by patterned electromagnetic radiation. At least a part of the pattern image associated with the object may be determined by identifying at least a part of the object in the at least one pattern image. Additionally and/or alternatively, at least one flood image may be received and at least a part of the pattern image associated with at least a part of the object may be determined by identifying the object in the at least one flood image. An object may be identified via algorithms implementing a model. Object may be identified based on spatial features associated with the object. Methods are known in the art for identifying an object in an image. For example, for identifying a face in an image, implementations are known in the state of the art. Objects may be identifiable by a specific combination of edges and/or specific distances between edges. For example, a face may be identified via facial features. Facial features may represent the edges of a face. For example, facial feature may comprise a nose, chin, eyes, eyebrows, glasses or the like may. Followingly, objects may be identified through spatial features of the object represented in the image. By identifying parts of the image referring to the object, speckle referring to the object may be determined. At least a part of the pattern image referring to the object may be determined by comparing the spatial position of the pattern image with the spatial position of the object. For this purpose, the pattern image may be used and/or a flood image may be used. Flood image may be used for referencing the spatial position of a speckle. Flood image may be a RGB image representing an object illuminated with electromagnetic radiation in the visible range and/or a flood IR image representing an object illuminated with electromagnetic radiation in the infrared range, preferably near-infrared range.

In an embodiment, identifying the object in the at least one pattern image and/or the at least one flood image may comprise determining at least one spatial feature associated with the object in the at least one pattern image and/or the at least one flood image.

In an embodiment, at least a part of the pattern image associated with at least a part of background may be removed.

In an embodiment, changing and/or removing at least a part of the spatial information of the pattern image may comprise representing the object as a two-dimensional plane.

In an embodiment, electromagnetic radiation may be in the infrared range.

In an embodiment, changing and/or removing at least a part of the spatial information may comprise generating at least two partial images. At least two partial images may be generated based on the at least one pattern image. A state of a material associated with the object may be determined based on at least one of the partial images. In some embodiments, a state of a material associated with the object may be determined based on at least two of the partial images. Since a state of a material is extracted from a partial image generated by manipulating the pattern image of the object the computing resources to identify the material can be reduced. Further by providing the partial images to the data-driven model, not the complete pattern image including, in particular, also potential background is utilized for the extracting of a state of a material. In addition, the part of the training process of the data-driven model that is necessary to train the identification model to unregard potential very variable background can be avoided leading to a decrease in the necessary training data. In particular, the size of a training data set may be decreased by a huge amount, as the data size of each of the partial images (which are many to achieve a well trained model) may be less or equal than the data size of each corresponding pattern image of the pattern images (which are many to achieve a well trained model). Hence, an accurate identification of a state of a material of an object and/or identification and/or authentication of an object and even in complex situations, e.g. where the object comprises or is covered by various, and possibly, unwished materials and is to be authorized as a user of a device to perform at least one operation on the device that requires authentication, is provided for which less training data for training a data-driven model needs to be utilized, in particular, technical efforts and requirements in terms of technical resources, costs and computing expenses are reduced. Accordingly, the data-driven model need fewer parameters, and thus, e.g. fewer neurons in the first layer. The sizes of the layer are thus smaller. All this further leads to a reduction of overfitting problems. All stated technical effects apply to the method, apparatus, data medium and uses of these of the invention, as the model is trained such that after training the model is utilizable by the method, apparatus, data medium and uses of these of the invention.

In an embodiment, at least one pattern image with at least a part of the spatial information changed and/or removed may be provided to a model and/or the state of the material associated with the object may be determined using a model.

In an embodiment, at least one pattern image with at least a part of the spatial information changed and/or removed is provided to a data-driven model and/or the state of the material associated with the object is determined using a data-driven model.

In an embodiment, the state of the material associated with the object may be compared to a threshold. A living organism may be detected when the state of the material associated with the object is larger than the threshold. A non-living organism may be detected when the state of the material associated with the object may be smaller or equal to the threshold. Comparing the vital sign measure with a threshold may be a part of an authentication process. Detecting a living organism may initiate and/or validate an authentication process. Detecting a non-living organism may decline an authentication process. Comparing the state of the material associated with the object with a threshold may be suitable for predicting the presence of a living organism. For example, the method for extracting a state of the material associated with an object may be used as part of an authentication process implemented on a device for providing access control for a user trying to access the device. A device may be, for example, a phone, a tablet, a laptop computer or a watch.

In an embodiment, determining a state of a material may comprise determining information related to the material associated with at least two spatial positions of the object. The at least two spatial positions may be different. The at least two spatial positions may be associated with the same or different material. The at least two spatial positions may refer to positions in the pattern image as generated. Spatial positions may change when changing and/or removing at least a part of the spatial information of the pattern image. At least one first state of a material may be associated with a first spatial position of the at least two spatial positions and at least one second state of a material may be associated with a second spatial position of the at least two spatial positions. A state of a material may be determined based on the at least one first state of a material and at least one second state of a material. Taking into account several parts of the image for determining whether the object presented is a human or a spoofing object enhances the security of authentication processes including the determination of a state of a material. Furthermore, determining a state of a material may be based on the at least one first state of a material associated with at least one first spatial position and at least one second state of a material may be associated with a second spatial position and the at least one first spatial position and the at least one second spatial position. By doing so, state of a material may be determined based one several states of material and the position associated with the more than one state of material. For example, in a face a state of a material may be determined associated with the nose and a state of a material my be determined associated with a cheek. State of a material associated with a nose and with a cheek may be different, e.g. due to different blood perfusion. Position associated with the state of material in the pattern image as generated may introduce the spatial relationship between the states of material associated with different spatial positions for determining an overall state of a material. Nose and cheek may have a characteristic difference in state of material, e.g. in blood perfusion and a characteristic difference in spatial position. A combination of spatial information associated with a state of a material and state of a material may represent a very unique property of real human skin and spoofing risk may be even lower. In the example, the distance between the position associated with the nose and the position associated with the cheek may further verify a user by combining the information about a state of a material and spatial information and thus, contribute to determining whether a human is present or not.

In an embodiment, the method further includes the step of predicting a presence of a living organism based on the state of the material associated with the object, preferably, as part of an authentication process. Preferably, the step of predicting of the presence of a living organism based on the state of the material associated with the object includes at least one of the substeps of
determining a confidence score based on the determined state of the material associated with the object,
comparing the confidence score to a predefined confidence threshold, and
predicting the presence of a living organism based on the comparison.

The confidence score may be generated from a state of the material associated with the object, e.g., represented by a single number or a value, or from a material state map, e.g., represented by a matrix of values associated with the state of the material associated with the object. The confidence score may represent a degree of confidence indicative of a presence of a living organism. The confidence score may be expressed by a single number or a value.

Preferably, the confidence score is determined by comparing the determined state of the material associated with the object to a reference, preferably associated with a particular confidence score.

Alternatively, the confidence score may be determined using a neural network that is trained for receiving the determined state of the material associated with the object as input and for providing the confidence score as output. The neural network may be trained with historic data representing historic state of the material associated with the object and associated confidence scores.

The confidence threshold may be predetermined to ensure a certain level of confidence that the object indeed is a living organism. The confidence threshold may be predetermined in dependence on a security level required for a specific application, e.g., for providing access to a device. For example, the confidence threshold may be set such that the confidence score may represent a comparatively high level of confidence, e.g., 90% or more, e.g., 99% or more, that the object presented to a camera is a living organism. Only when the comparison with the confidence threshold yields that the confidence score is high enough, i.e., exceeding the confidence threshold, the presence of a living organism is approved. If the confidence score is below the confidence threshold, access to the device will be denied. A denial of access may trigger a new measurement, e.g. a repetition of the method of extracting a state of the material associated with an object and of making use of the state of the material associated with the object for predicting the presence of a living organism as described before. Optionally, an alternative authentication process may be feasible. Thereby, it is possible to make sure that a requestor trying to gain access to a device actually is a living organism and not a spoofing attach. Additionally, it is possible to make sure that a requestor is authorized for the particular request.

The above-described method for extracting a state of the material associated with the object and the above-described method for predicting a presence of a living organism using a determined state of a material associated with an object may be part of an authentication process, in particular, further including biometric authentication, e.g., facial recognition and/or fingering sensing.

An authentication process may comprise the following steps:
performing biometric recognition of a user, e.g., on a user's face presented to a camera, or by determining a user's fingerprint with a fingerprint sensor, preferably, by conducting the sub-steps of
   providing a detector signal from a camera, said detector signal representing an image of a user's feature, e.g., a fingerprint feature or a facial feature;
   generating a low-level representation of the image; and
   validating an authorisation of the user based on the low-level representation of the image and a stored low-level representation template,
   if the biometric recognition is successful, determining a state of the material associated with the object, preferably, by conducting the steps of the method for extracting a state of the material associated with the object as described before,
   predicting based on the determined state of the material associated with the object a presence of a living organism, preferably, by
   determining a confidence score based on a determined state of the material associated with the object,
   comparing the confidence score to a predefined confidence threshold, and
   predicting the presence of a living organism based on the comparison;
providing a positive authentication output signal if the presence of a living organism is verified.

Upon receiving a positive authentication output signal the user may be allowed to access the device. Otherwise, in case of no living organism could be detected, a negative authentication output signal may be provided. In other words, generally, an authentication output signal may be provided indicative of whether a living organism has been presented to the camera. In case the biometric authentication already yields a negative result, a negative authentication output signal may be provided without determining the vital sign of the object.

In an alternative authentication process, initially a state of the material associated with an object of the object is determined and afterwards, in case of a successful verification of a presence of a living organism, the biometric authentication, e.g., facial recognition or fingerprint sensing, is carried out.

In one embodiment, the pattern images may be separated by a constant time interval associated with an imaging frequency or changing time intervals.

In another embodiment, the imaging frequency may be at least twice the motion frequency being associated with the expected periodic motion of a body fluid. An expected periodic motion of a body fluid may be associated with an expected periodic motion of the body fluid. The motion of the body fluid may be estimated based on the living organism and its surrounding.

In some embodiments, the living organism may be in motion relative to the camera, wherein the motion may not correspond to the motion of blood. In such a case, the image may be motion corrected. Such a correction aims at correcting the pattern image for the motion not related to blood perfusion. This can be done by tracking the motion of the living organism. By tracking the motion, a compensation factor can be determined suitable for subtracting from the feature contrast of a pattern image. The larger the movement of the living organism that is not related to blood perfusion, the larger the correction factor for subtracting is. The correction factor may be different for different parts of the pattern image. By doing so, the correction factor accounts for inhomogeneous movements over the pattern image. This is advantageous since it enables the use of pattern images where the living organism was in motion and thus, the pattern images do not need to be discarded and generating more pattern images can be avoided. Followingly, less data needs to be generated, processed and eventually stored, ultimately saving energy consumption.

In some embodiments, the step of providing the condition measure may be substituted by:
generating a signal indicating a condition-based action based on a comparison of the state of the material associated with an object with a threshold associated with a critical condition measure,
providing the signal indicating the condition-based action.

A condition-based action is a result of a comparison of the condition measure with the threshold. The condition measure may be determined as described herein. A signal indicating the condition-based action may be generated based on the comparison. The signal may be received by a condition controlling system. The condition-based action may be an advisory and/or interfering action. In some embodiments, the signal may indicate no action. If the condition measure of a living organism is below a threshold, the living organism should not be limited. The advisory action provides the living organism with advice. In some embodiments, the advisory action may provide another living organism with advice as the living organism from which the pattern images have been generated. In exemplary scenarios such as monitoring children, animals, humans with health issues, older humans, humans with a disability or the like humans responsible for taking care of the living organism may be notified. Humans responsible for taking care may be parents, caregiver, doctors, veterinarians or the like. The advisory action may comprise any form of providing advice in a form suitable for a living organism to recognize. Such advice may be for example advising the living organism to take a break, to drink and/or to eat, to change the conditions and/or the surrounding of the living organism, e.g. audio input, temperature, visual input, air circulation, etc. Examples for the form of advisory action can be visual through displaying functions, hearable through sound generating, e.g. a warning signal or tangible through vibrations. The interfering action may comprise any form of regulating the exterior. This is advantageous when the condition of a living organism is critical and can be improved by performing an interfering action. Such regulation may be for example, regulating the conditions and/or the surrounding of the living organism (e.g. audio input, temperature, visual input, air circulation, etc.), limiting the time during which the living organism may operate and/or control a mobile device and/or perform a certain task. In some scenarios, a preceding advisory action may be ignored by the living organism demanding interfering actions. In addition, very critical condition measures may be of higher risk and may be more adequately handled with interfering actions. Only slightly critical condition measures may be sufficiently handled with advisory action.

### BRIEF DESCRIPTION OF THE DRAWINGS

In the following, the present disclosure is further described with reference to the enclosed figures. The same reference numbers in the drawings and this disclosure are intended to refer to the same or like elements, components, and/or parts.

FIG. 1 illustrates an example embodiment of a device and a system for extracting a state of a material associated with an object.

FIGS. 2a, b illustrate example embodiments of an image having changed and/or removed at least a part of spatial information 200.

FIG. 3 illustrates a flowchart of an example embodiment of a method for extracting a state of a material associated with an object.

FIG. 4 illustrates an example embodiment of a method for extracting a state of a material associated with an object.

FIG. 5 illustrates an example embodiment of a temporal evolution of a vital sign measure map.

FIG. 6 illustrates an example embodiment of a pattern image after changing and/or removing at least a part of spatial information.

### DETAILED DESCRIPTION

The following embodiments are mere examples for implementing the method, the system or application device disclosed herein and shall not be considered limiting.

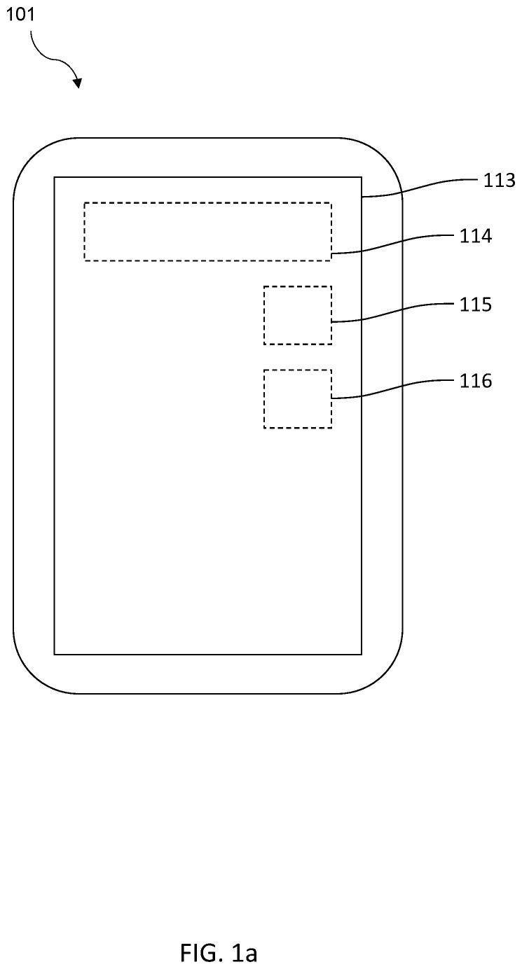

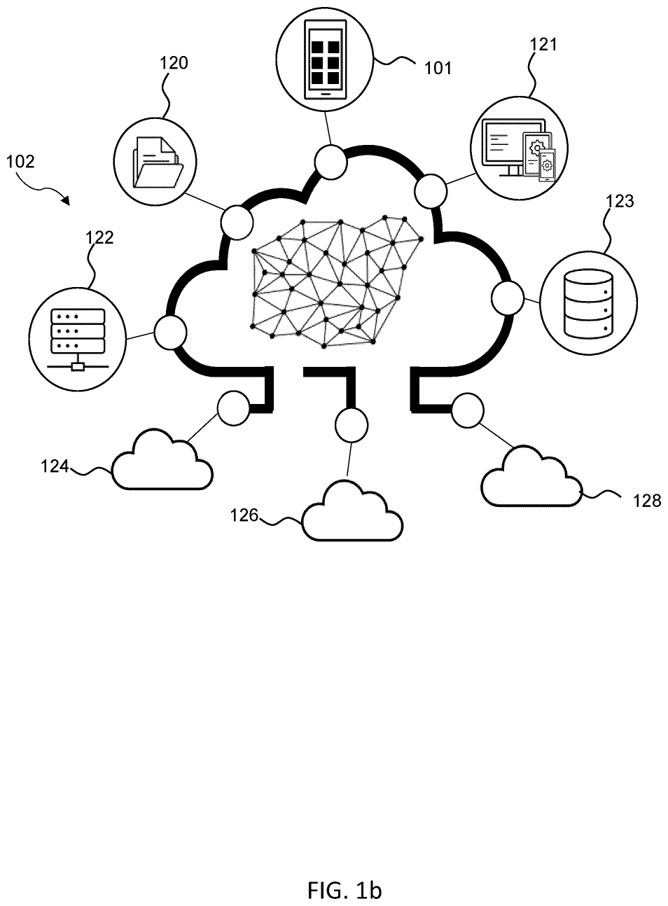

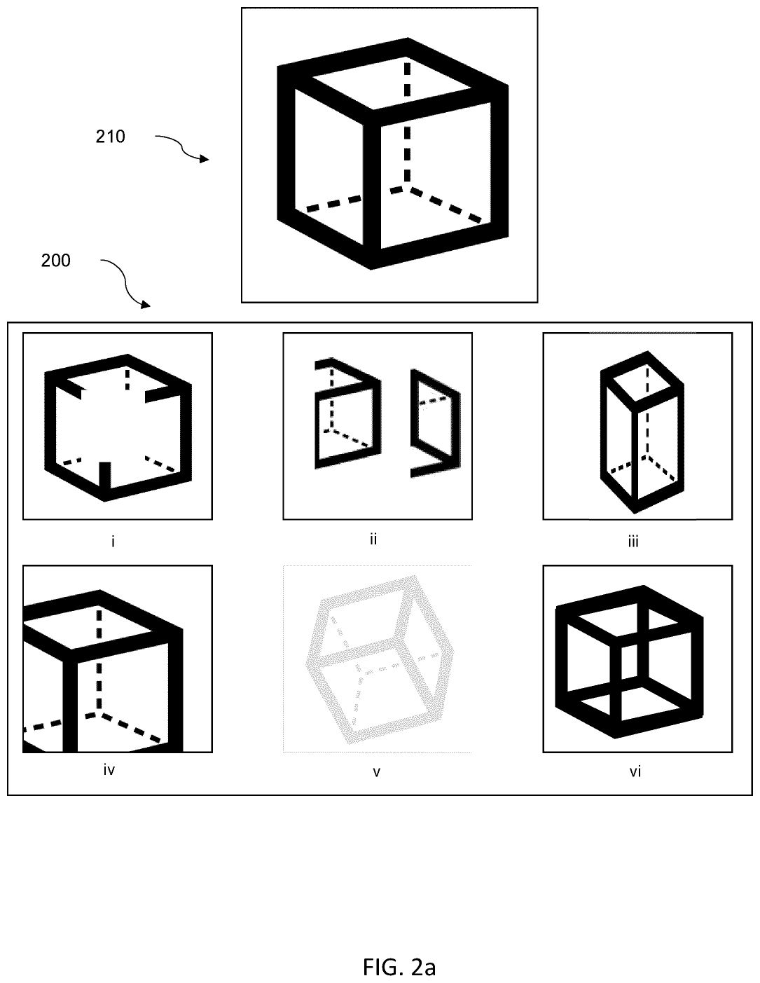

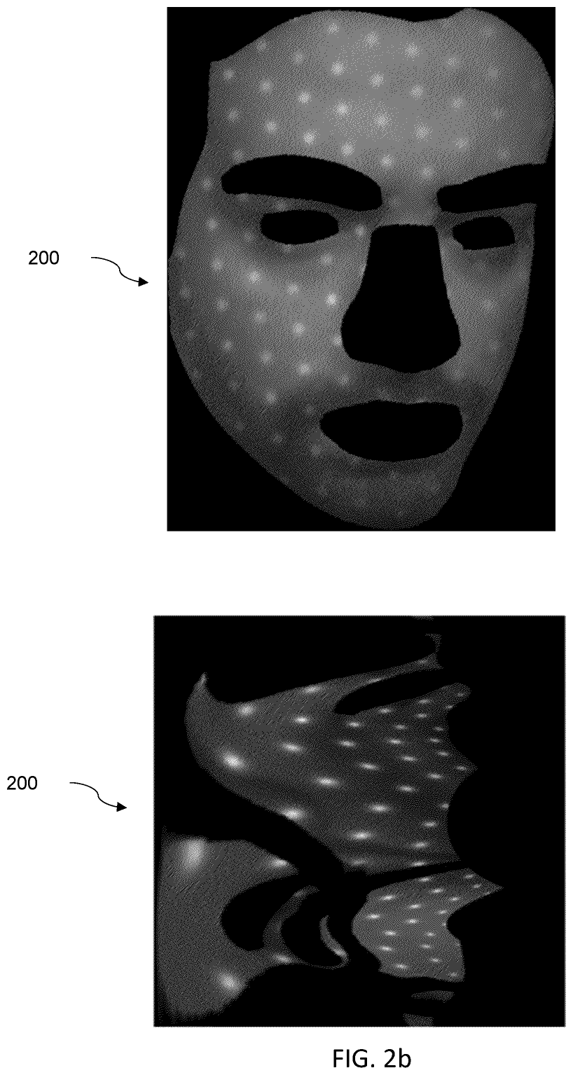

FIG. 1a illustrates an example embodiment of a device 101 for extracting a state of a material associated with an object. Device may be a mobile device, e.g. smartphone, laptop, smartwatch, tablet or the like, and/or a non-mobile device, e.g. desktop computer, authentication point such as a gate or the like. Device may be suitable for performing the actions and/or methods as described in FIG. 2-5. Device may be a user device. Device may include a processor 114, an imaging unit, an input 115, an output 116 and/or the like. Processor 114 may be provided with data via the input 115. Input 115 may use a wireless communication protocol. Data may be provided, e.g. to a user via the output 116. Output 116 may comprise a graphical user interface for providing information to the user. Output 116 may be suitable for providing data for example to another device. Output 116 may use a wireless communication protocol. Device may further comprise a display 113 for displaying information to the user. Device 101 may be a display device. Imaging unit may be suitable for generating an image, in particular an image of an object. Processor 114 may be connected to an input 115 and the output 116.

FIG. 1b illustrates an example embodiment of a system for extracting a state of a material associated with an object. System may be an alternative to a device 101 as described in FIG. 1a. System may comprise components of the device 101 as described in FIG. 1a. Components of device 101 may be distributed along the computing resources of the system.

System may be a distributed computing environment. In this example, the distributed cloud computing environment 102 may contain the following computing resources: device(s) 101, data storage 120, applications 121, server(s) 122, and databases 123. The cloud computing environment 102 may be deployed as public cloud 124, private cloud 126 or hybrid cloud 128. A private cloud 124 may be owned by an organization and only the members of the organization with proper access can use the private cloud 126, rendering the data in the private cloud at least confidential. In contrast, data stored in a public cloud 126 may be open to anyone over the internet. The hybrid cloud 128 may be a combination of both private and public clouds 124, 126 and may allow to keep some of the data confidential while other data may be publicly available. Components of the distributed computing environment 102 may carry out at least one step of the methods as described herein. In a non-limiting example, device 101 may generate an image and/or comprise an input for receiving a pattern image. Alternatively or additionally, pattern image may be received from a database 123 and/or a data storage 120 and/or a cloud 124-128 by a processor for carrying out the steps of the method. Processor may be or may be comprised by a server 122, a cloud 124-128. Applications 121 may include instructions for carrying out the steps of the method as described in the context of FIGS. 2 to 4.

FIGS. 2a, b illustrate example embodiments of an image having changed and/or removed at least a part of spatial information 200. The image as generated may be 210. The pattern image as generated 210 may show an arbitrary object. In FIG. 2a, the object may be a cube. In FIG. 2b, a three-dimensional representation of a face is illustrated.

In FIG. 2 a, examples i to vii represent different embodiments of an image having changed and/or removed at least a part of spatial information 200. Image i may be an image having changed at least a part of the image, deleted at least a part of the image, generated at least one partial image and/or a combination thereof. An example for an image augmentation technique performed may be cutting. Image ii may be an image having rearranged at least a part of the image, changed the distance between at least two spatial features and/or a combination thereof. Examples for image augmentation techniques performed may be cutting, rotating and/or a combination thereof. Image iii may be an image having changed at least a part of the image. Examples for image augmentation techniques performed may be scaling, shearing, folding and/or a combination thereof. Image iv may be an image having changed the distance between at least two spatial features, changed at least a part of the image, deleted at least a part of the image, rearranged at least a part of the image, generated at least one partial image, and/or a combination thereof. Examples for image augmentation techniques performed may be scaling, cutting, resizing and/or a combination thereof. Image v may be an image having changed at least a part of the image, rearranged at least a part of the image and/or a combination thereof. Examples for image augmentation techniques performed may be rotating, changing the contrast, changing the brightness, blurring and/or a combination thereof. Image vi may be an image having represented the object as a two-dimensional plane, changed at least a part of the image, deleted at least a part of the image and/or a combination thereof. Examples for image augmentation techniques performed may be warping, folding and/or a combination thereof.

Changing and/or removing at least a part of the spatial information of the at least one pattern image may comprise changing the distance between at least two spatial features, representing the object as a two-dimensional plane, changing at least one spatial feature, deleting at least one spatial feature, rearranging at least a part of the image, generating a blurred pattern image, generating an image with different contrast, generating an image with different brightness and/or all combinations thereof. Image augmentation techniques can change the data associated with the image.

In FIG. 2b an object, in this example a face with removed facial features such as eyebrows, eyes, nose and mouth, is shown. Some facial features may be present in the upper image such as a chin or an overall contour. FIG. 2b may be an overlay of the pattern image and a flood image. Hence, the image may be an example for changing and/or removing at least a part of the spatial information of the at least one pattern image. Flood image may be included for visualization of the object. Pattern image may be sufficient for extracting a state of a material.

Since in this image, a face may still be recognizable, the image may be manipulated further. For this purpose, the flood image may be used as a reference image for changing and/or removing at least a part of the spatial information by e.g. changing distances between the facial features, deleting rotating and/or shearing. In principle, the flood image may be manipulated such that the object is represented as a two-dimensional plane. An example for a representation of an object as a two-dimensional plane, in particular a face may be a partial or full UV map.

Another example for representing the object as a two-dimensional plane may be the lower image of FIG. 2b. Here, the face may be flattened and/or warped. In addition, the face in the exemplary pattern image and flood image may be distorted. This is beneficial since distorting the representation of the object as two-dimensional, e.g. by an image augmentation technique such as rotating, blurring, shearing or the like, may change and/or remove at least a part of the spatial information or may remove the spatial information completely. As pointed out above the flood image may be used as a reference for removing at least a part of the spatial information and based on this, the pattern image may be manipulated. The flood image may be a reference since the spatial features are visible to a user. Hence, it can be a straightforward implementation for changing and/or removing at least a part of the spatial information of at least a part of the pattern image. When using another image as a reference for manipulating the pattern image, image augmentation techniques may be applied to the other image for resulting in an image with less or no spatial information, the same image augmentation techniques with the same related parameters may be applied to the pattern image. By doing so, one can make sure that spatial information in the degree wanted can be changed and/or removed.

Another option for manipulating the pattern image can be manipulating the pattern image according to a known procedure. A known procedure may be a distinct selection of image augmentation techniques with corresponding parameters. This is especially advantageous when the object may be recognized in the pattern image and/or it is known how which image augmentation techniques may be applied to remove at least a part of the spatial features. Spatial features may comprise landmarks. Feature detection is known in the art, especially in the case of facial feature detection. Spatial information may be changed and/or removed by a processing unit such as a processor.

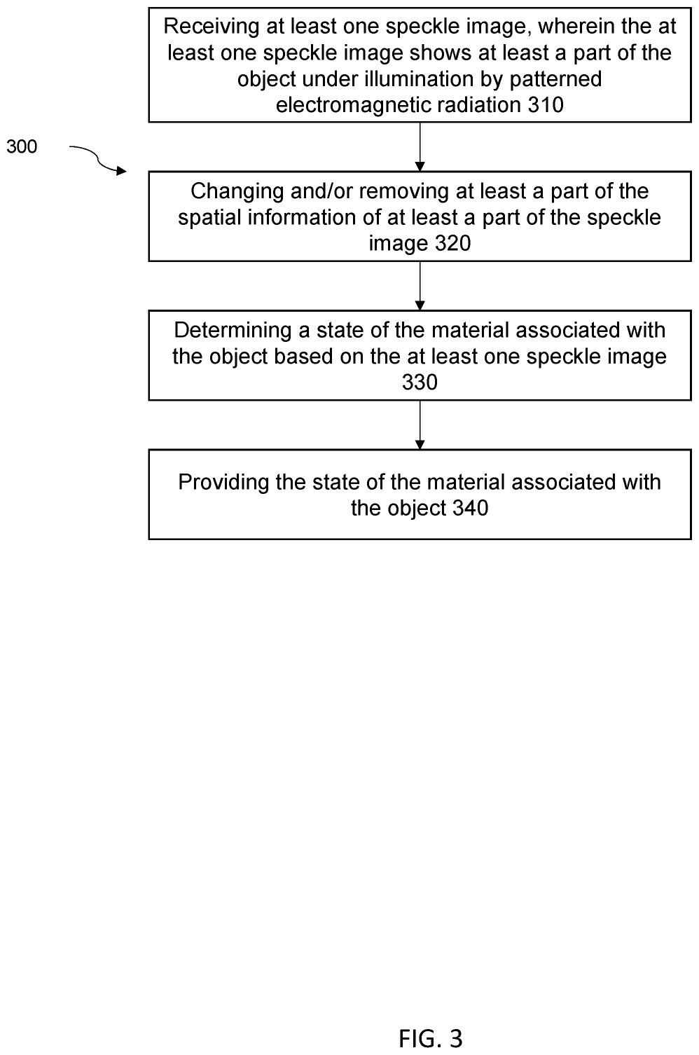

FIG. 3 illustrates a flowchart of an example embodiment of a method for extracting a state of a material associated with an object 300. In 310 a pattern image is received. Pattern image may be received via a communication interface. Pattern image may be received from an image generating unit such as a camera. Pattern image may comprise at least one speckle pattern with at least one speckle. The pattern image may be generated from coherent electromagnetic radiation reflected from at least a part of the object. Pattern image may show at least a part of the object under illumination by patterned electromagnetic radiation. Patterned electromagnetic radiation may be coherent electromagnetic radiation associated with a speckle pattern. The pattern image may be generated by a camera, e.g. a camera of a device, in particular a mobile device. Patterned electromagnetic radiation may be generated by an illumination source. Illumination source may be a part of a device, in particular a mobile device. For example, user may initiate an authentication process. Detecting a state of a material associated with an object may be a part of an authentication process. Pattern image may be received from the camera and/or the device with a camera. The spatial information in the received pattern image is changed and/or removed at least partially in 320. Changing and/or removing at least a part of the spatial information of at least a part of the pattern image may be as described in the context of FIG. 2.

State of a material associated with an object may be determined based on the pattern image 330. For example, the state of a material associated with an object may be provided to another device 101 and/or part of the system comprising a processing unit. Processing unit and/or device may be suitable for determining a state of a material associated with an object based on the manipulated image. In an embodiment, device 101 may be suitable for generating the pattern image and manipulating the pattern image and/or determining a state of a material associated with an object based on the manipulated pattern image. Device may be a smartphone suitable for performing an authentication process. User may initiate authentication process on smartphone including the detecting and/or predicting of a living organism. State of a material associated with an object may be determined based on the speckle contrast. Speckle contrast may be calculated as disclosed herein. Based on the speckle contrast, motion may be detected. Electromagnetic radiation reflected from a part of a moving object may be blurred more than when reflected from a part of a non-moving object. Movement may be caused by blood perfusion. Hence, detecting and/or predicting of a living organism may refer to detecting blood perfusion. A plurality of speckles may be used for determining a state of a material associated with the object.

In response to determining a state of a material associated with the object, the state of a material associated with the object is provided. State of a material associated with the object may be provided to be used in the authentication process. State of a material may indicate the probability for detecting a living organism and/or whether a living organism to be present. State of a material may be compared to a threshold. State of a material exceeding a threshold may indicate that a living organism may be present. State of a material being lower or equal to a threshold may indicate that no living organism is present.

State of the material associated with the object may be provided 340. State of the material associated with the object may be provided to another processing unit for further processing. State of the material may be provided via a communication interface, e.g. to a user or a system control.

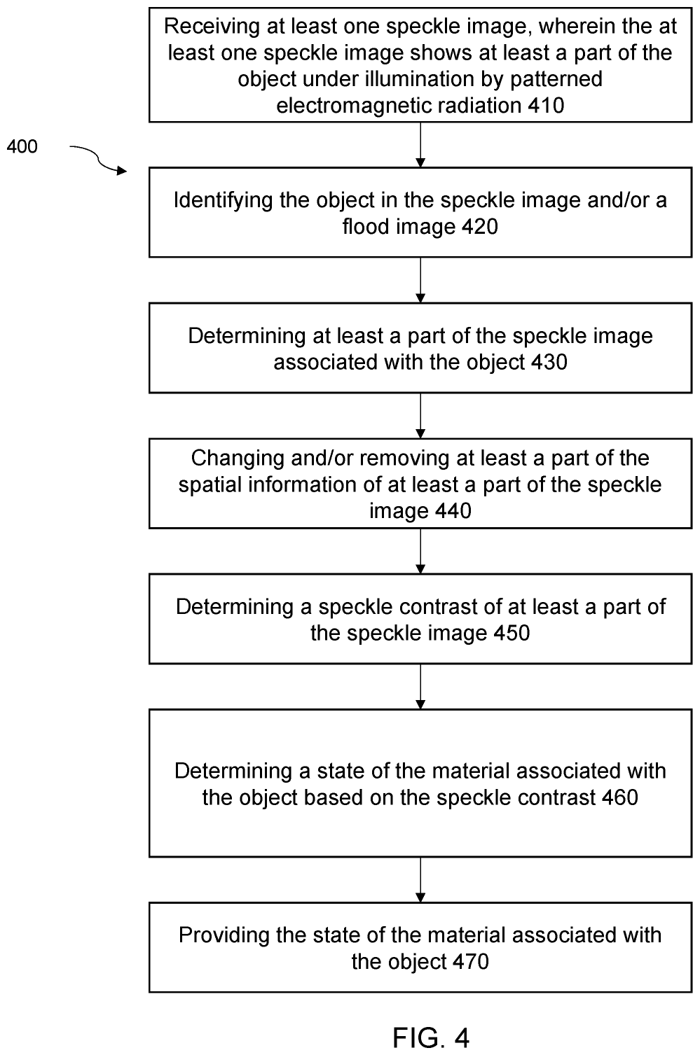

FIG. 4 illustrates an example embodiment of a method for extracting a state of a material associated with an object 400. Pattern image may be received 410 as described in the context of FIG. 3. Object may be identified in the pattern image and/or flood image 420. Object in pattern image may be identified due to spatial features. Spatial features may be characteristic for the object. Implementations for identifying object may be known in the art. For example, code may be readily available for identifying a face in an image. Characteristics of an object may be determined based on the spatial features associated with the object. Characteristics of an object may refer to its shape, the boundaries to other objects, colors, brightness, contrast, edges, distance to other objects, relation between two spatial features of the object and/or the like.

At least a part of the pattern image associated with the object may be determined based on identifying the object 430. Identifying the object may include determining the boundaries of the object. Based on the boundaries of the object, at least a part of the pattern image associated with the object may be determined. In an embodiment, at least a part of the pattern image may refer to a speckle. Speckle associated with the object may be a speckle reflected from the object. Determining speckle associated with object may comprise comparing spatial position of speckle and the spatial position of the object. Spatial position of the object may be determined by the boundaries. At least a part of the pattern image may be manipulated as described in the context of FIGS. 2 and 3.

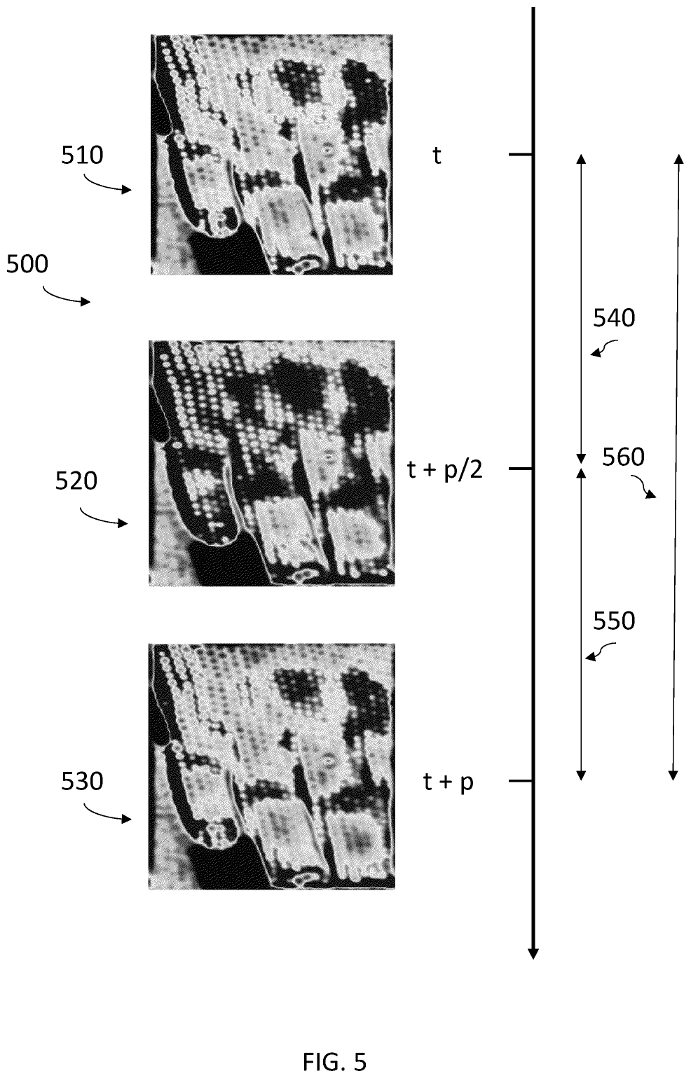

Speckle contrast of the speckle comprised in the pattern image may be determined 450 as described in FIG. 5.

State of a material associated with the object shown in the pattern image may be determined based on the speckle contrast 460. State of a material associated with the object may comprise a numerical value. State of a material associated with the object may indicate the probability that a living organism may be present. State of a material associated with the object may be derived from the speckle contrast. Speckle contrast may be lower if the probability that a living organism may be present may be high. Low speckle contrast may be caused by the part of the object reflecting the electromagnetic radiation being associated with motion. In particular, low speckle contrast may be associated with blood perfusion. High speckle contrast may be caused by the part of the object reflecting the electromagnetic radiation being in rest. In particular, low speckle contrast may be associated with a non-living object. Non-living object may experience no blood perfusion.

As stated before, the possible speckle contrast values are generally distributed between 0 and 1, with 0 representing maximal blurring and thus a maximum likelihood in favour of a presence of a living organism and with 1 representing minimum or even no blurring and thus a maximum likelihood that no living organism is present. The determined State of a material associated with the object may thus indicate based on the obtained speckle contrast value as obtained, e.g., with the mechanistic model, a certain likelihood that a living organism has been presented to the camera. For example, the state of a material associated with the object may indicate a likelihood of 100% for a living organism being present if the determined speckle contrast is 0. However, the state of a material associated with the object may indicate a likelihood of 0% for a living organism being present if the determined speckle contrast is 1. A speckle contrast of 0.5 may lead to a state of a material associated with the object indicating a likelihood of 50% for a living organism being present. Of course, it may be possible that a speckle contrast does not need to translate in a one-to-one manner to a corresponding percentage represented by a state of a material associated with the object. For example, a speckle contrast value of, e.g., 0.6 may lead to a state of a material associated with the object indicating a likelihood of at least 75% that an object presented to a camera is a living organism.

State of a material associated with the object may be provided 470 as described in the context of FIG. 3.

FIG. 5 illustrates an example embodiment of a temporal evolution of a material state map 500. In this example, the material state map may be a vital sign map. One image can be evaluated to yield a vital sign measure. More than one pattern image may be used for determining a condition measure. From the pattern image, a speckle contrast is determined. In the case that at least two pattern images may be received, a speckle contrast may be determined for the at least two pattern images. The several speckle contrasts can be combined in a vital sign measure map, e.g., represented by a matrix. The speckle contrast is determined by the standard deviation of the illumination divided by the mean intensity. The speckle contrast may range between 0 and 1 whereas the speckle contrast is 1 in case of no blurring of the speckles, i.e., no motion was detected in the illuminated volume of the object, and the speckle contrast is 0 in case of maximum blurring of the speckle due to detected motion of particles, e.g., red blood cells, in the illuminated volume of the object. Thus, the speckle pattern and the speckle contrast derived therefrom are sensitive to motion in the illuminated volume. This motion in the illuminated volume is indicative of the object being a living organism, since a living organism like a human or an animal has circulatory system for transporting blood cells within the body. In case, no blood circulation can be detected, it can be expected that an object is not a living organism. The stronger the blurring of the speckles is, the smaller is the derived speckle contrast. Thus, with a decreasing speckle contrast it is possible to more reliably detect a vital sign of an object. The speckle contrast can be determined from the full pattern image or from a section of the pattern image, e.g., obtained by cropping the full pattern image. Optionally, motion correction can be performed on the pattern image. This is advantageous in the case that the object has moved while capturing the pattern image.

From the speckle contrast, a vital sign measure may be determined. If a speckle contrast map has been determined from a series of pattern images, a vital sign measure map can be generated. A vital sign measure map may also be generated from a single pattern image, by dividing the pattern image into a number of partial pattern images and by determining a speckle contrast for each of the partial pattern images. Based on each of the speckle contrasts, implementing a speckle contrast map, a corresponding vital sign measure may be determined. The thus determined vital sign measures can be combined to a vital sign measure map. Thereby, the vital sign measures can be more accurately matched to certain positions on the object. In other words, it is possible to find a contribution of a part of the object to the total vital sign measure. For example, parts of an object exhibiting a comparatively high motion of fluid are expected to contribute more prominently to a total vital sign measure associated with the complete volume illuminated by coherent electromagnetic radiation.

Afterwards, the determined vital sign measure or the vita sign measure map is provided, e.g., to a user or to another component of the same device or to another device or system for further processing. For example, the vital sign measure may be used for predicting a presence of a living organism, e.g., as part of an authentication process implemented in a device as described with reference to FIG. 3. In particular, the vital sign measure is indicative of an object exhibiting a vital sign. The vital sign measure can thus be used for assessing whether an object presented to the camera is a living organism.

This can be represented by a blood perfusion map 510-530 as shown in FIG. 5. The map 510-530 can be colored according to the feature contrast, wherein a higher feature contrast value is represented with blue and a lower feature contrast value is represented with red. The spatial orientation of each pixel of the picture corresponds to the spatial orientation of a pixel of the pattern image with the corresponding feature contrast as determined. Blood perfusion map may be a vital sign map. Vital sign map may be determined based on speckle contrast.

The first pattern image may be generated at point t in time. The second pattern image may be generated at point t+p wherein p is the length of a period of the cardiac cycle associated with the heart rate. Furthermore, an indication of the interval between the different points in time where the pattern images may be generated are received. In the case of one pattern image at point t and another pattern image at point t+p the indication of the interval is suitable for determining the interval length of p. The feature contrast at point t and point t+p may be equal wherein the term equal is to be understood in the limitations of measurement uncertainty and/or biological variations. Condition measures underlie biological variations since the blood perfusion may deviate depending on various criteria. A data-driven model may be trained for compensating uncertainty and/or biological variations. A deterministic model may be suitable for compensating uncertainty and/or biological variations. For a determination of the condition measure more than two pattern images may be received. In a time series, imaging the temporal evolution of the blood perfusion is periodic due to the periodic heartbeat. A third pattern image between two images separated temporally by one period length may be advantageously to ensure a change in motion during the length of one period. For example, the pattern images may be generated or received with a virtual reality headset or a vehicle. In both scenarios, the monitoring of a living organism can be necessary in order to ensure a secure use of virtual reality (vr) technology and secure control over a vehicle of the living organism, especially in the context of driver monitoring the security aspect is expanded to the surrounding of the living organism. To do so, no direct contact to the living organism needs to be established and the living organism, preferably human, is not limited in any movement.

As an example, in FIG. 5 the temporal evolution of blood perfusion in a hand 500 can be seen. By generating several pattern images at different points in time, the blood flow and the heart rate can be visualized. Part 510 of FIG. 5 is a representation of a map of vital sign measures at point in time t showing a hand with a lower blood perfusion. Due to the heart activity responsible for pumping blood into the bloodvessels, the blood perfusion increases to a maximum in the hand at point in time t+p/2 520 where half of a period of the heart cycle passed. After reaching the maximum, the blood perfusion decreases until the initial blood perfusion is reached 530. The change in blood perfusion is visualized by the change in color wherein a high amount of red corresponds to a high amount of blood perfusion due to low feature contrast values and a high amount of blue corresponds to a low amount of blood perfusion due to high feature contrast values. The time passing between t and t+p/2 540 is equal to the time between t+p/2 and t+p 550 wherein p corresponds to the length of a period. Both intervals have a length of p/2. This is represented in FIG. 5 with arrows between the points in time. Another interval providing sufficient indication of time that has passed between at least two pattern images is the interval 560 of length p between the first pattern image 510 and the last pattern image 530. By recognizing a contrast change from the minimum to the maximum blood perfusion the interval of length p/2 can be used to determine the frequency of the heart rate. Alternatively, the interval of a full cycle of length p can also be used to determine the frequency of the heart rate, also called the motion frequency.

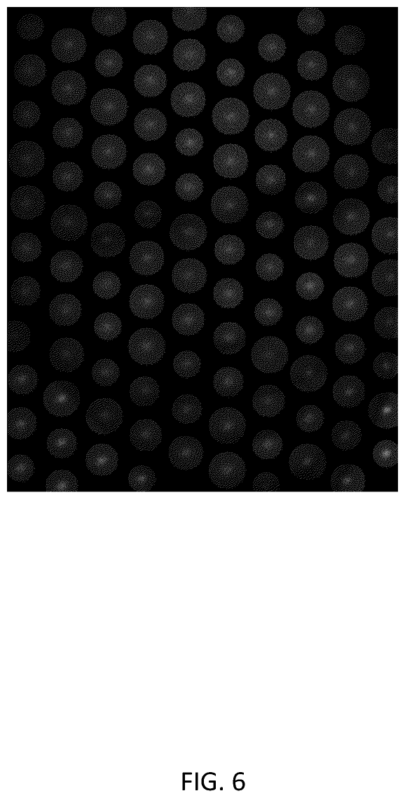

FIG. 6 illustrates an example embodiment of a pattern image after changing and/or removing at least a part of spatial information.

In an embodiment, changing and/or removing at least a part of the spatial information associated with a pattern image may include removing at least a part of the image within a predefined distance from one or more pattern features associated with the pattern image. Hence, the pattern image after changing and/or removing at least a part of the spatial information associated with a pattern image may show one or more parts of the pattern image, wherein the number of parts may be equal to the number of pattern features. This augmentation may be independent of the spatial features associated with the pattern image. Hence, determining a state of a material from the pattern image may be independent of the spatial features. Followingly, reliable determining of a state of a material is enabled and deciding whether a living organism has been presented to a camera

The present disclosure has been described in conjunction with preferred embodiments and examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place, i.e. each of the steps may be performed at different places using different data processing equipment.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Any disclosure and embodiments described herein relate to the methods, the systems, used, the computer program element lined out above and vice versa. Advantageously, the benefits provided by any of the embodiments and examples equally apply to all other embodiments and examples and vice versa.

1. A computer-implemented method for extracting a state of a material associated with an object, the method comprising:
a) receiving at least one pattern image, wherein the at least one pattern image shows at least a part of the object under illumination by patterned electromagnetic radiation,
b) changing and/or removing at least a part of the spatial information of the pattern image, wherein spatial information comprises information related to the spatial orientation of the object and/or to the contour of the object and/or to the edges of the object,
c) determining a state of the material associated with the object based on the at least one pattern image, and
d) providing the state of the material associated with the object.

2. The method according to claim 1, wherein the patterned electromagnetic radiation is coherent, and wherein the state of the material associated with the object is determined based on a speckle contrast of at least a part of the pattern image, wherein the speckle contrast represents a measure for a mean contrast of an intensity distribution within an area of a speckle pattern.

3. The method according to claim 1, wherein the at least one pattern image further shows at least a part of background under illumination by patterned electromagnetic radiation, and wherein at least a part of the pattern image associated with the object is determined by identifying at least a part of the object in the at least one pattern image and/or wherein at least one flood image is received and at least a part of the pattern image associated with at least a part of the object is determined by identifying the object in the at least one flood image.

4. The method according to claim 3, wherein identifying the object in the at least one pattern image and/or the at least one flood image comprises determining at least one spatial feature associated with the object in the at least one pattern image and/or the at least one flood image.

5. The method according to claim 1, wherein the object is a living organism.

6. The method according to claim 1, wherein changing and/or removing at least a part of the spatial information of the pattern image comprises performing at least one image augmentation technique.

7. The method according to claim 1, wherein the electromagnetic radiation is in the infrared range.

8. The method according to claim 1, wherein at least two pattern images and an indication of at least one interval between at least two different points in time, where the at least two pattern images have been generated, are received, and wherein a speckle contrast is determined for the at least two pattern images, and wherein a state of the material associated with the object is determined based on the speckle contrast and the indication of the at least one time interval, wherein the speckle contrast represents a measure for a mean contrast of an intensity distribution within an area of a speckle pattern.

9. The method according to claim 1, wherein the at least one pattern image with at least a part of the spatial information changed and/or removed is provided to a data-driven model and/or the state of the material associated with the object is determined using a data-driven model, wherein the data-driven model may be parametrized according to a training data set and wherein the training data set may include at least one pattern image with changed and/or removed spatial information and at least one state of a material.

10. The method according to claim 1, wherein changing and/or removing at least a part of the spatial information of the pattern image comprises representing the object as a two-dimensional plane.

11. A computer-implemented method for training a data-driven model for extracting a state of a material associated with an object, the method comprising:
a) receiving a training data set comprising at least one pattern image with changed and/or removed spatial information and a state of a material associated with an object,
b) training a data-driven model according to the training data set, and
c) providing the trained data-driven model.

12. A method of using the state of a material as obtained by claim 1 associated with the object in an authentication process, the method comprising using the state of a material for initiating and/or validating the authentication of a user.

13. A method, comprising:
using at least one pattern image with changed and/or removed spatial information, the method comprising: using the at least one pattern image with changed and/or removed spatial information for extracting a state of a material associated with an object; and/or
using a state of a material associated with an object, the method comprising using the state of a material associated with an object for predicting the presence of a living organism.

14. A computer program element with instructions, which when executed on a processing device is configured to carry out the steps of the method of claim 1.

15. A system or a device for extracting a state of the material associated with an object, the system comprising:
a) an input for receiving at least one pattern image, wherein the at least one pattern image shows at least a part of the object under illumination by patterned electromagnetic radiation,
b) a processor for changing and/or removing at least a part of the spatial information of the pattern image and determining a state of the material associated with the object based on the at least one pattern image, and
c) an output for providing the state of the material associated with the object.
